(19) United States
(12) Patent Application Publication
(10) Pub. No.: US 2025/0139036 A1
(43) Pub. Date: May 1, 2025

(54) DAISY CHAIN COMMUNICATION SYSTEM AND METHOD, BATTERY MANAGEMENT SYSTEM

(71) Applicant: Joulwatt Technology Co., Ltd., Hangzhou (CN)

(72) Inventors: Yating LU, Hangzhou (CN); Zhuhaobo ZHANG, Hangzhou (CN)

(21) Appl. No.: 18/930,797

(22) Filed: Oct. 29, 2024

(30) Foreign Application Priority Data
Oct. 31, 2023 (CN) 202311428761.2

(51) Int. Cl. G06F 13/362; G06F 13/42; H01M 10/42

(52) U.S. Cl. CPC G06F 13/362; G06F 13/4247; H01M 10/425; H01M 2010/4271

(57) ABSTRACT

A daisy chain communication system and method, and a battery management system are provided. The daisy chain includes a first slave controller and a plurality of second slave controllers, and a master controller transmits command information to the plurality of second slave controllers through the first slave controller. The daisy chain responses to the command information. A network response period is divided into a plurality of sub phases. The second slave controller transmits transmission data with a consistent data length to a slave controller of an upstream node cascaded therewith at each sub phase; the first slave controller transmits the transmission data from the second slave controller cascaded therewith at each sub phase to the master controller. In the present disclosure, a data length transmitted by each slave controller is consistent, so that equalization of power consumption between corresponding battery modules that supply power to each slave controller is achieved.

### CROSS-REFERENCE TO RELATED APPLICATIONS

This present disclosure claims priority to a Chinese patent application No. 2023114287612, filed on Oct. 31, 2023, and entitled “daisy chain communication system and method, battery management system”, the entire contents of which are incorporated herein by reference, including the specification, claims, drawings and abstract.

### FIELD OF TECHNOLOGY

The present disclosure relates to a field of communication technology, and particularly, to a daisy chain communication system and method, and a battery management system.

### BACKGROUND

In a large-scale energy storage system, in order to reduce system costs, centralized battery management system (BMS) based on daisy chain communication technology is widely used. A battery pack in BMS includes a plurality of battery modules, so a plurality of analog front end (AFE) chips should be connected in series.

The power consumption of the AFE chip mainly includes ADC conversion power consumption, general purpose input output (GPIO) control power consumption, peripheral power consumption and communication power consumption. Since the ADC, GPIO configuration, control logic and peripherals of each AFE chip are consistent, the ADC conversion power consumption, GPIO control power consumption and peripheral power consumption generated by this part of function are the same. The communication power consumption of the AFE chip is generated during a communication process. According to a communication mechanism of the daisy chain, all communication data needs to be transmitted through a previous AFE chip. A communication data volume of the daisy chain remote AFE chip is smaller than that of proximal AFE chip, resulting in different communication power consumption of each AFE chip on the daisy chain, thereby each AFE chip has different total power consumption. Since the AFE chip takes power directly from the battery when it is working, it consumes battery power. The total power consumption of each AFE chip is different for a long time, resulting in poor battery cell consistency, and the battery capacity corresponding to the proximal AFE chip of the daisy chain becomes smaller. Therefore, it is necessary to improve on the problems existing in the prior technology.

### SUMMARY OF THE DISCLOSURE

In view of above problems, an object of the present disclosure is to provide a daisy chain communication system and method, a battery management system, so that a plurality of slave controllers in a daisy chain network transfer the same length of data over time, and equalization of communication power in the daisy chain network is improved.

According to an aspect of the present disclosure, a daisy chain communication system is provided and includes: a master controller; a daisy chain including a first slave controller and a plurality of second slave controllers, the first slave controller being coupled to the master controller; wherein the master controller is configured to transmit command information to the plurality of second slave controllers through the first slave controller, and receives network response information from the daisy chain for the command information, the daisy chain is configured to perform an operation function including: dividing a network response period into a plurality of sub phases, and each of the second slave controller transmitting transmission data with a consistent data length to a slave controller of an upstream node cascaded therewith at each sub phase, wherein the transmission data includes one of response information of the second slave controller itself, response information of a slave controller of a downstream node and a first fake data; in a transfer order of the command information, the slave controller of the upstream node is a slave controller close to a side of the master controller; the slave controller of the downstream node is a slave controller away from the side of the master controller; and the first slave controller transmitting the transmission data from the second slave controller cascaded therewith at each sub phase to the master controller until all the response information of the plurality of second slave controllers is transmitted to the master controller.

Optionally, the first slave controller is configured to receive the command information from the master controller; and transmit the command information sequentially to each second slave controller in a cascading order of the daisy chain.

Optionally, each second slave controller is configured to transmit the transmission data to the slave controller of the upstream node cascaded therewith in a case that the command information or a response request is received at each sub phase.

Optionally, each second slave controller is configured, so that in a case that the command information is received, the transmission data transmitted to the slave controller of the upstream node cascaded therewith is the response information of the second slave controller itself; in a case that the response request is received, the transmission data transmitted to the slave controller of the upstream node cascaded therewith is one of the response information of the slave controller of the downstream node and the first fake data.

Optionally, the first slave controller is further configured to generate the response request at each sub phase after transmitting the transmission data from the second slave controller cascaded therewith to the master controller, and to transmit the response request sequentially to each second slave controller.

Optionally, the first slave controller is further configured to transmit the response information of the first slave controller itself to the master controller after receiving the command information.

Optionally, each of the first slave controller and the plurality of second slave controllers includes a first data buffer and a second data buffer, wherein, in each slave controller, the second data buffer is configured to cache the transmission data from the slave controller of the downstream node, the first data buffer is configured to store data of the slave controller itself, or to extract data from the second data buffer of the slave controller itself and transmit it to the slave controller of the upstream node or the master controller.

Optionally, a common protocol is adopted for communication between the master controller and the first slave controller.

Optionally, two interfaces are arranged in each slave controller, and each interface has a transmitting and receiving function; in the plurality of second slave controllers, the second slave controller located last in a cascading order is further configured to transmit a second fake data through its own idle interface after receiving the command information, wherein the second fake data has a same data length as the command information; the idle interface is an interface that is not coupled to other slave controllers.

Optionally, two interfaces are arranged in each slave controller, and each interface has a transmitting and receiving function; the first slave controller is further configured to transmit a plurality of first fake data that has the same number as the plurality of second slave controllers through its own idle interface during the network response period; the idle interface is an interface that is not coupled to other slave controllers.

Optionally, the daisy chain includes n second slave controllers, n being a positive integer greater than 1, when a communication interruption is in any two adjacent second slave controllers, n second slave controllers are divided into x second slave controllers and y second slave controllers based on a position of the communication interruption, both x and y being positive integers greater than or equal to 1, and x+y=n; the x second slave controllers and the first slave controller form a first daisy chain network; the y second slave controller and the first slave controller form a second daisy chain network.

Optionally, when x is equal to y, the first daisy chain network and the second daisy chain network are configured to perform a same operation as the operation function; a total data length of the response information transmitted by each second slave controller in the first daisy chain network and the second daisy chain network is a sum of data lengths of x/y response information; when x is greater than y, the first daisy chain network is configured to perform the same operation as the operation function; a total data length of the response information transmitted by each second slave controller in the second daisy chain network is a sum of data lengths of x response information; when y is greater than x, the second daisy chain network is configured to perform the same operation as the operation function; a total data length of the response information transmitted by each second slave controller in the first daisy chain network is a sum of data lengths of y response information.

Optionally, two interfaces are arranged in each slave controller, and each interface has a transmitting and receiving function; in the first daisy chain network or the second daisy chain network, the second slave controller located last in the cascading order is further configured to transmit a second fake data through its own idle interface after receiving the command information, wherein the second fake data has a same data length as the command information. the idle interface is an interface that is not coupled to other slave controllers.

Optionally, when x is equal to y, a total data length of the response information transmitted by the first slave controller is a difference between the sum of the data lengths of the x/y response information and a data length of the command information; when x is greater than y, the total data length of the response information transmitted by the first slave controller is a difference between the sum of the data lengths of the x response information and the data length of the command information; When y is greater than x, the total data length of the response information transmitted by the first slave controller is a difference between the sum of the data lengths of the y response information and the data length of the command information.

According to another aspect of the present disclosure, a battery management system is provided and includes: a battery pack including a plurality of battery modules; and an above-mentioned daisy chain communication system.

According to another again aspect of the present disclosure, a daisy chain communication method is provided, wherein the daisy chain includes a first slave controller and a plurality of second slave controllers, the first slave controller is coupled to a master controller, the communication method includes: step 1: transmitting command information to the plurality of second slave controllers through the first slave controller by the mater controller; step 2: performing a network response to the command information by the daisy chain; step 3: dividing a network response period into a plurality of sub phases, and transmitting transmission data with a consistent data length by the second slave controller to a slave controller of an upstream node cascaded therewith at each sub phase, wherein the transmission data includes one of response information of the second slave controller itself, response information of a slave controller of a downstream node and a first fake data; in a transfer order of the command information, the slave controller of the upstream node is a slave controller close to a side of the master controller; the slave controller of the downstream node is a slave controller away from the side of the master controller; and transmitting the transmission data from the second slave controller cascaded with the first slave controller to the master controller by the first slave controller at each sub phase until all the response information of the plurality of second slave controllers is transmitted to the master controller.

Optionally, further including: arranging two interfaces in each slave controller, wherein each interface has a transmitting and receiving function; wherein in the plurality of second slave controllers, the second slave controller located last in a cascading order is further configured to transmit a second fake data through its own idle interface after receiving the command information, the second fake data has a same data length as the command information; the idle interface is an interface that is not coupled to other slave controllers.

Optionally, two interfaces are arranged in each slave controller, and each interface has a transmitting and receiving function; the first slave controller is further configured to transmit a plurality of first fake data that has the same number as the plurality of second slave controllers through its own idle interface during the network response period; the idle interface is an interface that is not coupled to other slave controllers.

Optionally, the daisy chain includes n second slave controllers, n being a positive integer greater than 1, when a communication interruption is in any two adjacent second slave controllers, n second slave controllers are divided into x second slave controllers and y second slave controllers based on a position of the communication interruption, both x and y being positive integers greater than or equal to 1, and x+y=n; the x second slave controllers and the first slave controller form a first daisy chain network; the y second slave controller and the first slave controller form a second daisy chain network.

Optionally, when x is equal to y, the first daisy chain network and the second daisy chain network are configured to perform a same operation as in step 3; otherwise, a length of the response information transmitted by each second slave controller and the first slave controller is determined based on a maximum value in x and y.

The present disclosure has at least following beneficial effects:

In the present disclosure, by transmitting and receiving the fake data in the plurality of slave controllers of the daisy chain communication network, a data length transmitted over the network by each slave controller over time is the same when responding, so that each slave controller consumes the same amount of communication-related power from a corresponding battery module of the battery pack, and equalization between the battery modules is improved.

Further, when responding, by transmitting the fake data that has the same number as the plurality of slave controllers other than an initial node by the initial node (a length of the fake data is consistent with a length of the data in the response information), or by further transmitting the fake data with a length being consistent with the length of the data in the command information by the slave controller of last node, or determining the length of the data transmitted by each slave controller based on one of the first daisy chain network and the second daisy chain network having a largest number of the second slave controllers, the equalization of power consumption between the plurality of slave controllers could be further improved. The battery pack with the battery management system having this daisy chain communication network to experience a shorter equalization time than adopting other types of battery management systems.

### BRIEF DESCRIPTION OF THE DRAWINGS

The foregoing and other objects, features and advantages of the present disclosure will become clearer by the following description of embodiments of the present disclosure with reference to the accompanying drawings.

FIG. 1 is a structural block diagram of a system with a daisy chain communication network according to an embodiment of the present disclosure.

FIG. 2 is a data structure diagram of a daisy chain communication network according to an embodiment of the present disclosure.

FIGS. 3A and 3B show a transmission schematic diagram of a daisy chain communication network during a response process according to an embodiment of the present disclosure, respectively.

FIG. 4A shows a timing schematic diagram of command transmission and response receiving of a daisy chain communication network in a broadcast mode according to an embodiment of the present disclosure.

FIG. 4B shows a data transmission amount of each each slave controller in a daisy chain communication network during a response process according to an embodiment of the present disclosure.

FIG. 5 shows a structural block diagram of a system with a daisy-chain communication network during a communication interruption according to the present disclosure.

FIG. 6 shows a schematic diagram of a data amount of command information transmitted by each controller in the system of FIG. 5.

FIG. 7 shows a schematic diagram of a data amount of response information transmitted from each of controllers in the system of FIG. 5.

FIG. 8 shows a schematic flowchart of a method according to another embodiment of the present disclosure.

### DETAILED DESCRIPTION OF THE DISCLOSURE

Exemplary embodiments of the present disclosure will now be described in detail, examples of which are shown in the accompanying drawings. Through the embodiments described below with reference to the accompanying drawings, the advantages and features of the present disclosure and methods of implementation thereof will be set forth. However, the present disclosure may be implemented in different forms and should not be construed as being limited to the embodiments set forth herein. Rather, these embodiments are provided to make the present disclosure comprehensive and complete in order to adequately communicate to those skilled in the art the scope of the present disclosure.

The shapes, sizes, ratios, angles, and numbers disclosed in the drawings used to describe embodiments of the present disclosure are by way of example only, and thus the present disclosure is not limited to the details illustrated. Similar reference numerals always indicate similar elements. In the following description, the detailed description will be omitted when it is determined that a detailed description of the relevant known function or construction will inevitably obscure the focus of the present disclosure.

In the case of using the terms “including”, “having” and “containing” as described in this specification, another part of may be added unless “only” is used. Unless stated to the contrary, singular terms may include plural objects.

In describing the positional relationship, for example, when the positional relationship between two parts is described as, for example, “on”, “above”, “below”, or “next one”, one or more other parts may be set between the two parts unless “only” or “directly” is used. When describing temporal relationships, for example, when a temporal sequence is described as “after”, “after”, “next”, or “before”, discontinuities may be included unless “just”, or “directly”, are used.

It should be understood that while the terms “first”, “second”, etc. may be used herein to describe various components, these components should not be limited by these terms. These terms are used only to distinguish one part from another. For example, without departing from the scope of the present disclosure, the first component can be referred to as the second component, and similarly, the second component can be referred to as the first component.

The term “at least one” should be understood to include any combination of one or more of the items listed accordingly. For example, the meaning of “at least one of the first project, the second project, and the third project” means a combination of all projects proposed from two or more of the first project, the second project, and the third project, as well as the first project, the second project, or the third project.

As will be well understood by those skilled in the art, the features of the various embodiments of the present disclosure may be part of or wholly associated or combined with one another and may be interoperable operated and technically driven in various ways with one another. Embodiments of the present disclosure may be performed independently of one another, or may be performed together in an interdependent relationship.

Hereinafter, exemplary embodiments of the present disclosure will be described in detail with reference to the accompanying drawings.

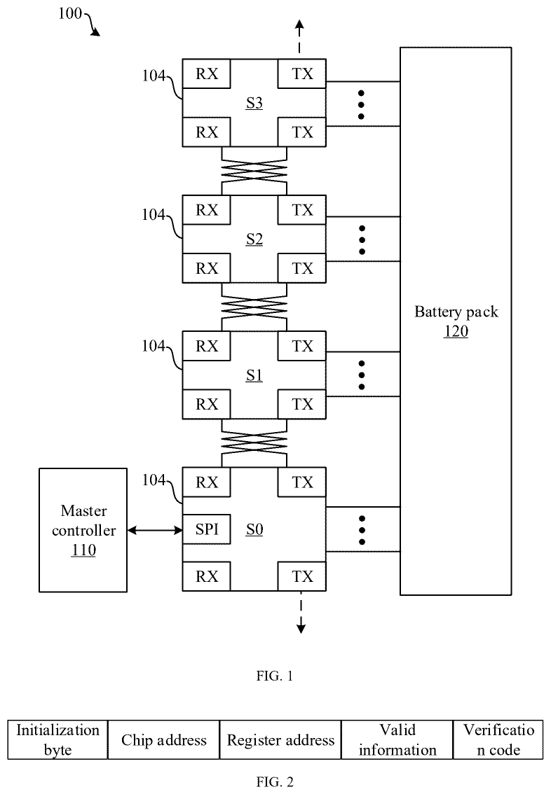

FIG. 1 is a structural block diagram of a system with a daisy chain communication network according to an embodiment of the present disclosure. A system 100 may represent any type of battery management system, particularly in a field of high-voltage battery management. For example, the system 100 may form part of an electrical energy storage system of an electric or hybrid vehicle, a commercial or domestic electrical energy storage system, or any other type of electrical energy storage system that adopts a daisy chain communication network to manage energy storage of individual battery cell of the system. As shown in FIG. 1, the system 100 includes a master controller 110, a battery pack 120, and a plurality of slave controllers 104 (e.g., including slave controllers S0-Sn, n is a positive integer equal to or greater than 2). For ease of illustration, four slave controllers are shown in FIG. 1, which are represented sequentially from bottom to top, respectively, including controllers S0, S1, S2, and S3. Of course, the description of the four slave controllers 104 in FIG. 1 is exemplary, and one skilled in the art may configure one, two, or more slave controllers 104 according to actual needs.

The battery pack 120 represents a high-voltage battery system, wherein the high-voltage battery system includes any number of low-voltage battery cells connected in series, and the low-voltage battery cell stores electrical energy for powering the system (e.g., an electric propulsion system of a car). A voltage of the battery pack 120 at a specific time corresponds to a sum of individual voltages of each cell in the battery pack 120 at this time. For example, the battery pack 120 may include a plurality of individual battery cells that provide a voltage required by the system 100 when combined in series. To facilitate battery management of the system 100, the battery cells of the battery pack 120 could be grouped into modules having one or more battery cells, wherein each module has its own monitoring and balancing electronic. For example, each module may include a single unit, 12 units, 14 units, 16 units, or any other number of units that may be required for battery management.

The master controller 110 performs a function related to battery management for the system 100, and the function includes charging and discharging of a plurality of modules configured to control the battery pack 120. As some examples, the master controller 110 could monitor a total voltage of the battery pack 120 and a voltage of an individual module of the battery pack 120 to determine whether to start charging or to discharge an electrical energy stored in the battery pack 120. The master controller 110 may include any suitable configuration of hardware, software, firmware, or any combination thereof to perform a communication control method described herein. The master controller 110 could transmit commands to one or more of the plurality of slave controllers S0 to S3, so that one or more slave controllers reports a operation state (including voltage, temperature, etc.) of a corresponding module in the battery pack 120 during a response process. The master controller 110 performs a state assessment and internal troubleshooting of the battery pack 120 and the corresponding module thereof according to a received voltage state, temperature state, etc.

The master controller 110 may include any one or more of micro control unit (MCU), digital signal processor (DSP), application specific integrated circuit (ASIC), field programmable gate arrays (FPGA), or any other equivalent integrated or discrete logic circuit device, and any combination of these components. When the master controller 110 includes software or firmware, the master controller 110 further includes any hardware necessary to store and execute the software or firmware, such as one or more processors or processing units. In general, the processing unit may include one or more of micro control unit, DSP, ASIC, FPGA, or any other equivalent integrated or discrete logic device, and any combination of these components.

Each slave controller 104 may include monitoring and balancing electronics associated with a corresponding battery module in the battery pack 120. For example, the slave controller 104 could be an AFE (an analog front end) chip, and the AFE chip mainly serve as a battery sampling chip in the battery management system (BMS), for example, could be used to collect operation state information such as the voltage and temperature of the battery module. Each slave controller 104 may include a voltage monitoring circuit for detecting a voltage level of the corresponding battery module of the battery pack 120 and reporting a detected voltage as data to the master controller 110. Moreover, each slave controller 104 may further include a temperature monitoring circuit for detecting the temperature of the corresponding battery module and reporting a detected temperature as data to the master controller 110. Each slave controller 104 may further include a communication electronic for acquiring a command based on the data receives from the master controller 110 and converting a measured voltage level into data that transmits a response information to the master controller 110. Moreover, each slave controller 104 may receive current or power required for each period of communication (e.g., transmission and response) on the network from the corresponding battery module; That is, each slave controller 104 is powered by the corresponding battery module.

A plurality of slave controllers 104 that are cascading coupled form a daisy chain communication network of the system 100. According to a relative positional relationship between the plurality of slave controllers 104 and the master controller 110, the slave controller S0 in the plurality of slave controllers 104 coupled to the master controller 110 is defined as a slave controller of an initial node, and the slave controller S3 located topmost in the plurality of slave controllers 104 or farthest from the master controller 110 is defined as a slave controller of last node or final node. Alternatively, according to a transfer order of command information, each slave controller being close to a side of the master controller is defined as a slave controller of “upstream node”, and each slave controller being away form the side of the master controller is defined as a slave controller of “downstream node”. The initial node (i.e., the slave controller S0) in the plurality of slave controllers 104 is coupled to the master controller 110 and communicate directly with the master controller 110 through a shared interface between the two (which may employ a common protocol, e.g., a serial peripheral interface (SPI) bus), without a separate bridging chip between the two. Of course, the slave controller S0 could be served either as the AFE chip to monitor the corresponding battery module or as the bridge chip, and the present disclosure is not limited to this.

In this embodiment, the slave controller S0 and the master controller 110 could communicate through common protocols such as SPI, I2C, UART, etc. Taking SPI communication as an example, the slave controller S0 receives the command information from the master controller 110 through a SPI bus, transmits the command information to subsequent slave controllers S1 to S3 in a cascading order, and receives all response information transmitted by the slave controllers S1 to S3 in the cascading order, and provides the response information to the master controller 110 through the SPI bus in a set timing order.

In various embodiments, a variety of communication protocols may be employed between adjacent slave controllers 104 in the daisy chain communication network. For example, differential asynchronous communication may be employed between adjacent slave controllers 104, master controller 110 is configured to transmit an instruction through the SPI bus to the slave controller S0 (which may be defined as a first slave controller) of the initial node in the plurality of slave controllers 104, and slave controller S0 of the initial node is configured to convert the instruction into data packets of a preset format to be transmitted the daisy chain communication network, so that the data packet is transmitted to the slave controller of the final node or a addressed slave controller (which may be defined as a second slave controller) through the daisy chain communication network. The plurality of slave controllers104 are further configured to provide their own response information to the slave controllers of their upstream nodes upon receiving information of the command instructions, transmit the response information of the controllers S1 to S3 to the master controller 110 through the slave controller S0 in a step-by-step feedback manner in combination with a set timing.

Specifically, each of the plurality of slave controllers104 of the present embodiment includes two interfaces, and each interface has a transmitting and receiving function data. As shown in FIG. 1, each slave controller including an RX (receiving terminal) and a TX (transmitting terminal) would be taken as an example.

As an example, the slave controller S1 could receive the command information from the slave controller S0 through the daisy chain communication network and perform actions in response to the command (e.g., the slave controller S1 may close a switch in a voltage detection circuit that could be used to measure the voltage level of the corresponding battery module in the battery pack 120). Then the slave controller S1 could convert a detected voltage into a data response information and transmit it to the slave controller S0 that is an upstream node of the slave controller S1, and the response information is provided to the master controller 110 through the SPI bus by the slave controller S0.

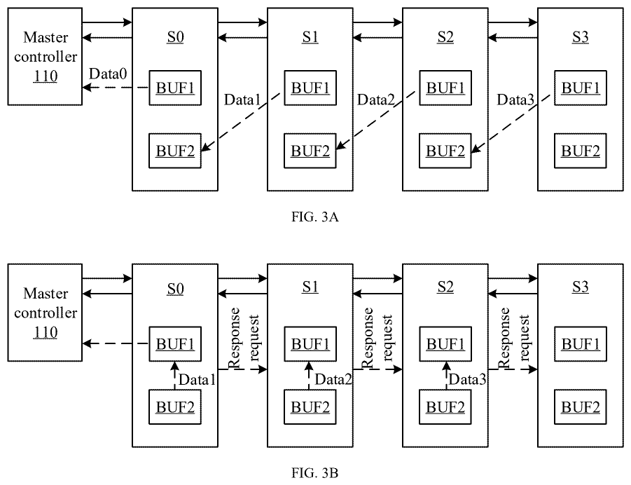

FIG. 2 shows a data structure diagram of a daisy chain communication network according to an embodiment of the present disclosure. The master controller 110 and the plurality of slave controllers 104 in the daisy chain communication network of the present embodiment adopt data packets to transmit information with each other, and the command information issued by the master controller 110 and the response information returned by the slave controller 104 are all transmitted by use of a data packet structure. Various encoding protocols (e.g., differential Manchester encoding, biphasic marker encoding, Manchester encoding, non-return-to-zero, inverted (NRZI) encoding with run-length limitations or any other suitable encoding) may be employed in the daisy chain communication network of the present embodiment. As shown in FIG. 2, the data packet structure of the present embodiment includes at least an initialization byte, a chip address, a register address, valid information, and a verification code. Wherein, the initialization byte includes a type of information (indicating whether the information is the command information or the response information), and various modes of command (which may include, for example, broadcast mode), wherein the master controller 110 issues the command information to all slave controllers S0-S3 in broadcast mode; a mode may also be included, in which the master controller 110 issues command information to the slave controllers S1-S3 other than the controller S0 serving as the initial node. The chip address indicates an object address of the command or an address of transmitting response. The register address represents a configuration information operation or a writing address of a register. The valid information could be data information such as voltage or temperature sampled by the slave controller 104, as well as configuration information of the master controller 110 to the slave controller 104, and may include other required data information. The verification code mainly includes a cyclic redundancy check (CRC) protection code, which could be used to detect whether a bit flip or some sudden error occurs during data transmission.

As described in more detail below, the plurality of slave controllers 104 of the communication system in the present embodiment could transmit and receive the same number of command information and response information over time in the network. In this way, regardless of the position of each slave controller 104 relative to the master controller 110, each slave controller 104 may consume the same amount of communication-related power from the corresponding battery module of the battery pack 120 over time, so that each slave controller 104 has the same communication load that requires each slave controller 104 to transmit and receive the same number of bits of data. In this way, the controller 110 may enable the battery pack 120 to experience a shorter balancing time than adopting other types of battery management systems.

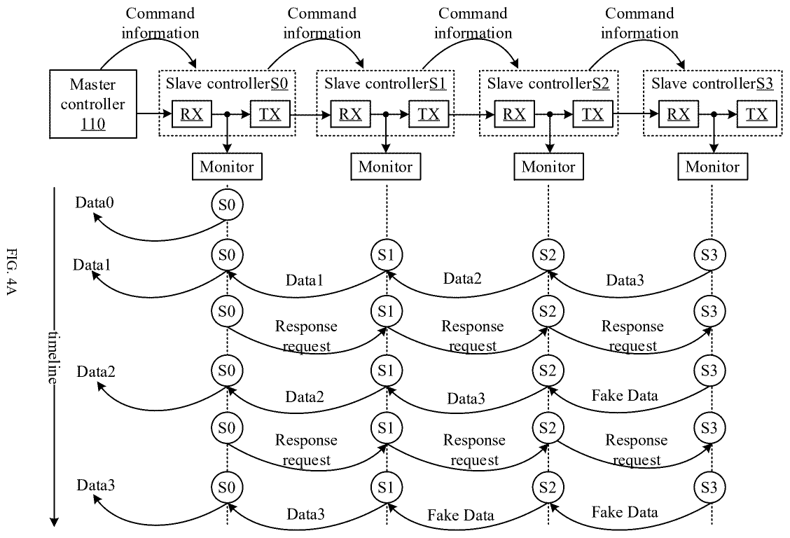

FIGS. 3A and 3B show a transmission schematic diagram of a daisy chain communication network during a response process according to an embodiment of the present disclosure, respectively. As shown in FIGS. 3A and 3B, each of the plurality of slave controllers S0-S3 of the present embodiment includes data buffers BUF1 and BUF2, wherein the data buffer BUF2 of each slave controller receives and caches response information from the slave controller of the downstream node, and each data buffer BUF1 of the slave controller is configured to cache its own data or extract data from its own data buffer BUF2 and output it to the slave controller of the upstream node.

It should be noted that a command and response strategy of the daisy chain communication network in the broadcast mode of the present embodiment is different from a traditional communication method. The traditional communication method needs to first transmit the command information from bottom to top (for example, from the initial node to the final node) through the daisy chain communication network to each slave controller, and then reverse a direction of the bus communication during a response period of the network, and transmit a response data from top to bottom through the daisy chain to respond to the command. Moreover, during the response process, each slave controller should integrate the response information from the slave controller of the downstream node and its own response information into a new response information, and transmit the new response information sequentially from top to bottom in the daisy chain communication network until all response data is integrated and transmitted to the master controller 110 by the slave controller of the initial node.

However, forwarding of the command information and transmitting of the response information of the daisy chain communication network of the present embodiment occur almost synchronously. When the master controller 110 transmits the command information to the plurality of slave controllers S0 to S3 in the broadcast mode, each slave controller 104 responds to the command information after receives the command information, transmits the response information to the upstream node thereof, and the response information is transmitted to the master controller through the slave controller of the upstream node at a subsequent time, thereby reducing communication time and improving communication efficiency.

As shown in FIG. 3A, the slave controller S0 could receive the command information from the master controller 110 through the SPI bus, and read the response information Data0 from its own data buffer BUF1 and transmit it to the master controller 110 through the SPI bus after receiving the command information. At the same time, the slave controller S0 forwards the command information to the slave controller S1. After receives the command information, the slave controller S1 reads the response information Data1 from its own data buffer BUF1 and transmits it back to the slave controller S0 serving as the upstream node of the slave controller S1. The slave controller S0 could store the response information Data1 of the slave controller S1 in its own data buffer BUF2. Similarly, the slave controller S1 forwards the command information to the slave controller S2, and repeats above process until the command information is forwarded to the slave controller of the final node (e.g., the slave controller S3).

In addition, in this embodiment, the slave controller S0 serving as the initial node only transmits one set of response information at a time, and transmits a response request to the slave controller 104 of the downstream node to request the response information stored in the slave controller 104 of the downstream node after transmitting the response information. As shown in FIG. 3B, the data buffer BUF1 of the controller S0 read the response information Data1 of the slave controller S1 from the data buffer BUF2, and transmit the response information Data1 to the master controller 110 through the SPI bus. Then, the slave controller S0 transmits the response request to the slave controller S1, and the slave controller S1 reads the response information Data2 of the slave controller S2 from the data buffer BUF2 after receiving the response request, and transmits it to the slave controller S0 through the daisy chain network. The slave controller S1 transmits the response request to slave controller S2, and the slave controller S2 repeats the above process after receiving the response request until all the response information of slave controllers S1-S3 is transmitted to the master controller 110 through the slave controller S0.

However, there is a disadvantage in this manner. By replicating broadcasts and responses in the network more frequently, one or more slave controllers 104 positioned close to a start of the daisy chain consume more power over time than the one or more slave controllers 104 positioned near an end of the daisy chain, resulting in an imbalance in power consumption associated with communication between modules of the battery system.

In order to balance the communication power consumption of the daisy chain communication network, the daisy chain communication network of the present disclosure further includes: each slave controller 104 generating a segment of fake data having a set length if there is no response information stored in the data buffer when responding to the response request, and then sending the fake data to the slave controller 104 of the upstream node, so that the plurality of slave controllers 104 transmit and receive the same number of response information on the network over time. In this way, regardless of the position of each slave controller 104 relative to the master controller 110, the controller 110 may cause each slave controller 104 to consume the same amount of communication-related power over time from the corresponding battery module of the battery pack 120.

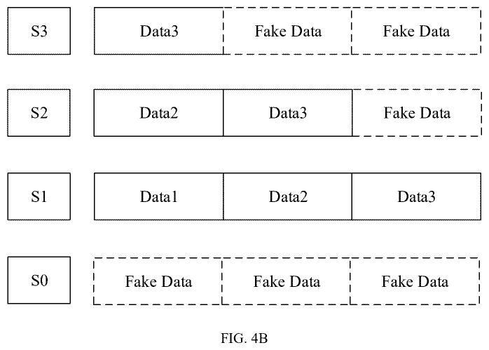

FIGS. 4A and 4B show, respectively, a timing schematic diagram of command transmission and response receiving of a daisy chain communication network in a broadcast mode and a data transmission amount of each each slave controller during a response process according to an embodiment of the present disclosure.

In FIG. 4A, the daisy chain communication network of the present embodiment communicates according to a timeline, and the command information issued by the master controller 110 is transmitted the daisy chain communication network though the controller S0, for example, the command information from the master controller 110 is received by the controller S0 through the SPI bus. Then each slave controllers S1 to S3 could monitor an interface close to the upstream node and copy the command information received through another interface until the command information reaches the addressed slave controller or the slave controller of the final node.

During the network response period, firstly, the response information Data0 is generated by the slave controller S0 after receiving the command information, and then the response information Data0 is transmitted to the master controller 110 through the SPI bus. Then, after receiving the command information, the slave controllers S1-S3 sequentially transmit their own response information Data1-Data3 to the slave controllers of the upstream nodes through the daisy chain. Moreover, after the slave controller S0 receives the response information Data1 of the slave controller S1, the response information Data1 is transmitted to the master controller 110 through the SPI bus, and the slave controllers S1 and S2 respectively store the response information from the slave controller of the downstream node (for example, the response information Data2 of the slave controller S2 and the response information Data3 of the slave controller S3). After transmitting the response information Data1 of the slave controller S1, the slave controller S0 transmits the response request to the slave controller S1, and then the slave controllers S1 to S3 sequentially copy the response request received through the interface near the upstream node along the daisy chain through the interface near the downstream node. After the slave controllers S1 to S3 receiving the response request, respectively, the slave controller S1 transmits the stored response information Data2 to the slave controller S0, the slave controller S0 transmits the response information Data2 to the master controller 110 through the SPI bus, the slave controller S2 transmits the stored response information Data3 to the slave controller S1, and the slave controller S3 generates a piece of fake data Fake Data and transmit it to the slave controller S2. After the slave controller S0 transmitting the response information Data2, the slave controller S0 transmits the response request to the slave controller S1 again. The slave controllers S1 to S3 sequentially copy the response request. Then, the slave controller S1 transmits the stored response information Data3 to the slave controller S0, and the slave controller S0 transmits the response information Data3 to the master controller 110 through the SPI bus. At the same time, the slave controllers S2 and S3 respectively generate a segment of fake data Fake Data to the upstream node after receiving the response request. After receiving the virtual data, the upstream node may not process the fake data accordingly, that is, the fake data may be ignored.

As shown in FIG. 4B, when responding, a data length transmitted by the slave controller S1 in the network is equal to a sum of the response information Data1 to Data3, a data length transmitted by the salve controller S2 in the network is equal to a sum of the response information Data2 to Data3 and the fake data Fake Data, and a data length transmitted by the salve controller S3 in the network is equal to a sum of the response information Data3 and two fake data Fake Data. By setting the fake data Fake Data to have the same data length as the response information, it could be seen that the data length transmitted by the slave controllers S1 to S3 in the network over time is the same when responding.

In addition, in the response period, the slave controller S0 mainly communicates with the master controller 110 through the SPI bus, one of the interfaces is in an idle state, considering that power consumption of transceivers between the slave controllers is much greater than power consumption of a SPI transceiver, and if no adjustment is made, it may cause the power consumption of the slave controller S0 to be less than the power consumption of the slave controllers S1-S3. Thus, as shown in FIGS. 1 and 4B, when responding, the present embodiment further includes equalizing the power consumption of communication between the controller S0 and the slave controllers S1-S3 by transmitting multi-segment fake data Fake Data equal to the number of slave controllers in the daisy-chain communication network except for the slave controller S0 through the idle interface of the slave controller S0 (for example, the slave controller S0 transmits three segments of fake data Fake Data in FIG. 4B).

The communication between the slave controller S0 and the master controller 110 through SPI is described above as an example, but the present disclosure is not limited thereto. The slave controller S0 and the master controller 110 may also communicate using a common protocol other than SPI, and the principles are the same as described above.

Further, in order to further improve the effect of power consumption equalizing and ensure power equalization in the broadcast process, the present embodiment further includes a slave controller (e.g., from controller S3) as the final node, after receiving the command information from an interface close to its upstream node, transmitting a segment of fake data consistent with a data length of the command information through its own idle interface to ensure that each slave controller 104 could transmit and receive command data of the same length through the interface.

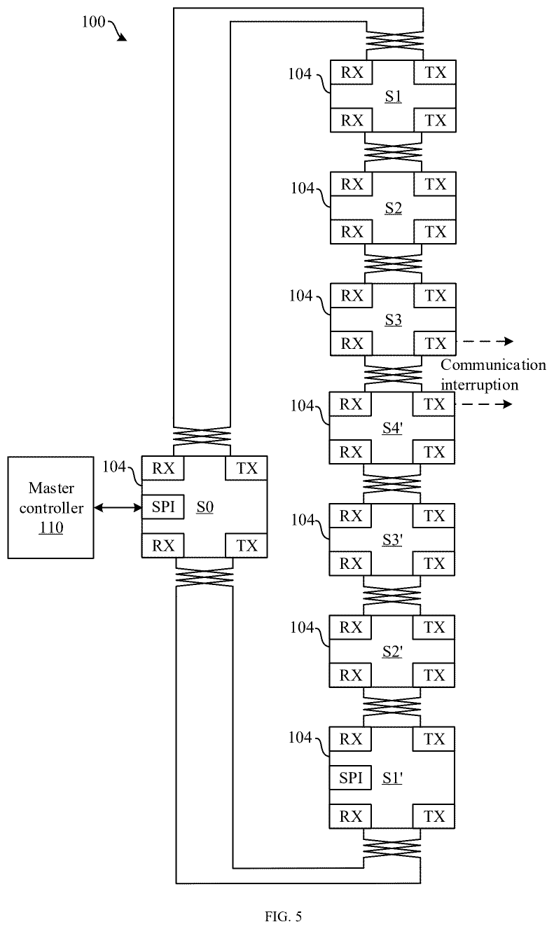

The above description achives the equalization of power consumption between the slave controllers based on in a case that all communication between the slave controllers is normal. Further, as shown in FIG. 5, when there is a communication interruption in the daisy chain network, as shown in FIG. 5, taken the communication interruption in the slave controllers S3 and S4′ as an example. Seven second slave controllers (which may also be other numbers) are illustrated in FIG.5. At a location of the communication interruption, the seven second slave controllers are divided into two groups, the slave controllers S1, S2, S3 are a first group, the slave controllers S4′, S3′, S2′ and S1′ are a second group, that is, the first group includes 3 second slave controllers, and the second group includes 4 second slave controllers, wherein the first group of slave controllers and the slave controller S0 form a first daisy chain network, and the second group of slave controllers and the second group of slave controller S0 form a second daisy chain network.

In order to maintain the equalization of power consumption between the slave controllers in different daisy chain networks, since the number of second slave controllers in the first daisy chain network is less than the number of second slave controllers in the second daisy chain network, based on the principles described above, it could be seen that at this time, if two independent daisy chain networks work separately, the energy consumption of the slave controllers in the two daisy chain networks will be uneven. Therefore, the second daisy chain network could operate with reference to the working principle in FIG. 1 to achieve equalization of power consumption of the salve controllers S4′, S3′, S2′and S1′; The first daisy chain network operates differently in that the data length finally transmitted by each slave controller should be referenced to a total data length transmitted by each slave controller in the second daisy chain network.

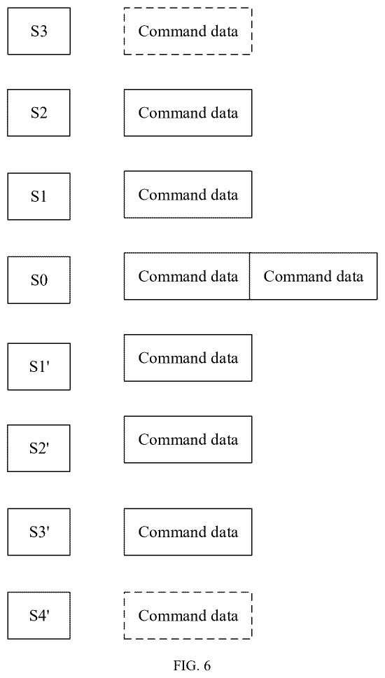

FIG. 6 is a schematic diagram of a data amount of each command information transmitted by the slave controller based on the system in FIG. 5. Wherein, based on the principle of the daisy chain network operation described above, one command information is transmitted by the slave controllers S1, S2 and S3′, S2′ and S1′. In order to maintain the equalization of the power consumption between the slave controllers, one command information is transmitted by the slave controllers S3 and S4′ at its idle interface; since the slave controller S0 transmits the command information at both two interface, two command information are transmitted from controller S0.

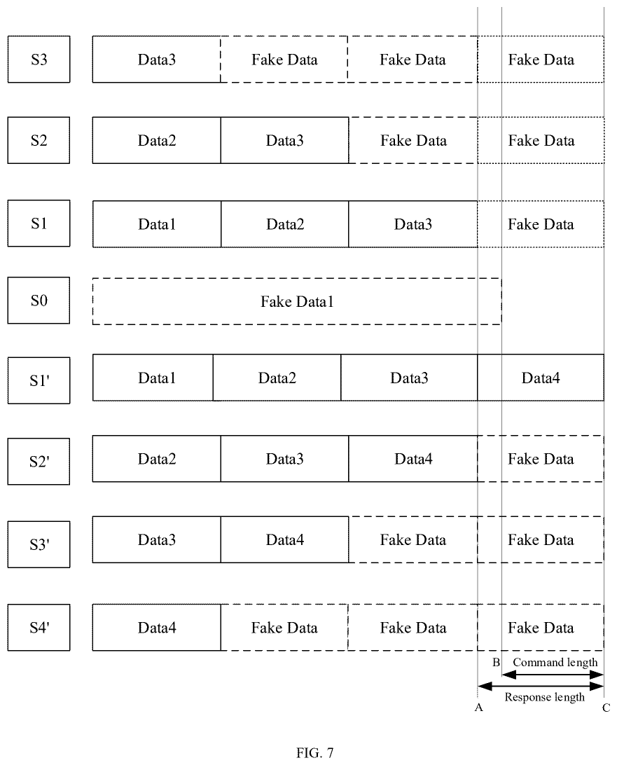

FIG. 7 is a schematic diagram of a data amount of each command information transmitted by the slave controller based on the system in FIG. 5. Wherein, a data amount before point A represents the data amount of the response information transmitted by the slave controllers S1, S2, S3 when the first daisy-chain network operating alone, and a data amount before point C represents the data amount of the response information transmitted by the slave controllersS4′, S3′, S2′, and S1′ when the first daisy-chain network operating alone, and the data length of the response information differs by one between points A and C. Therefore, in order to maintain the equalization of power consumption between each slave controller, it is necessary to transfer a fake data (the same length as the response information) from the controllers S1, S2, S3 again, as represented by a denser dashed wire frame in FIG. 7. Through the above configuration, the equalization of power consumption between the corresponding second slave controllers could be achieved when the daisy chain is interrupted.

Further, in order to maintain the equalization of power consumption between the slave controller S0 and the second slave controllers, it is necessary for the salve controller S0 to transmit the fake data with a length being a difference between a data length of 4 response information and the length of one command information. Since the slave controller S0 transmits one more command information length relative to the other slave controllers, the length of one command information is removed, as shown in FIG. 7, the length of the fake data is the length before point B, so that the equalization of the total power consumption transmitted between the slave controller S0 and the slave controllers S1, S2, S3 and the slave controllers S4′, S3′, S2′ and S1′ is maintained.

In addition, FIG. 5 shows a case that the first daisy chain network and the second daisy chain network having two different numbers of second slave controllers when communication is interrupted, and of course can also have the same number, for example, including three second slave controllers, respectively. In a case of the same number, both the first daisy chain network and the second daisy chain network data transmission can refer to the working principle in FIG. 1.

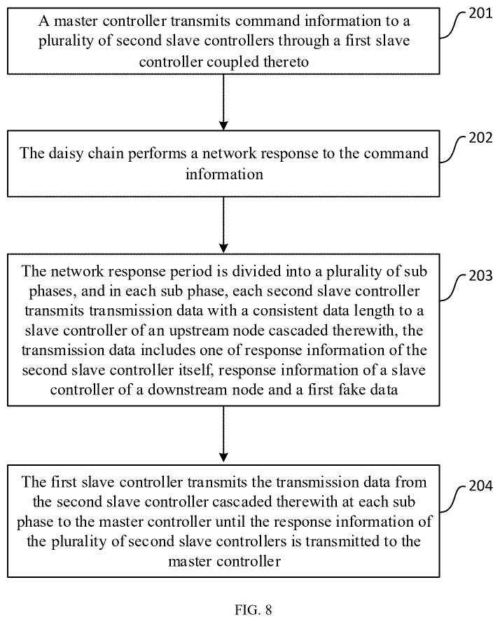

FIG. 8 shows a schematic flowchart of a method according to another embodiment of the present disclosure. The daisy-chain communication method could be applied to the master controller 110 in the system 100 of FIG. 1 to achieve equalization of communication power consumption among the plurality of slave controllers in the daisy chain network.

As shown in FIG. 8, in step 201, a master controller 110 transmits command information to a plurality of second slave controllers through a first slave controller (e.g., a slave controller S0) coupled thereto.

In step 202, the daisy chain performs a network response to the command information.

In step 203, the network response period is divided into a plurality of sub phases, and in each sub phase, each second slave controller (e.g., slave controllers S1-S3) transmits transmission data with a consistent data length to a slave controller of an upstream node cascaded therewith, the transmission data includes one of response information of the second slave controller itself, response information of a slave controller of a downstream node and a first fake data.

In step 204, the first slave controller transmits the transmission data from the second slave controller cascaded therewith at each sub phase to the master controller until all the response information of the plurality of second slave controllers is transmitted to the master controller.

In addition, the principle of the daisy chain communication method of this embodiment is consistent with that described in the daisy chain communication network above, and will not be repeated here.

In summary, in the present disclosure, by transmitting and receiving the fake data in the plurality of slave controllers of the daisy chain communication network, the data length transmitted over the network by each slave controller over time is the same when responding, so that each slave controller consumes the same amount of communication-related power from a corresponding battery module of the battery pack, and equalization between the battery modules is improved.

Further, when responding, by transmitting the same number of fake data as the plurality of slave controllers other than an initial node by the initial node (a length of the fake data is consistent with a length of the data in the response information), or by further transmitting the fake data with a length being consistent with the length of the data in the command information by the slave controller of last node, or determining the length of the data transmitted by each slave controller based on one of the first daisy chain network and the second daisy chain network having a largest number of the second slave controllers, the equalization of power consumption between the plurality of slave controllers could be further improved. The battery pack with the battery management system having this daisy chain communication network to experience a shorter equalization time than adopting other types of battery management systems.

In the above description, the known structural elements and steps are not described in detail. However, it should be understood by those skilled in the art that the corresponding structural elements and steps can be achieved by various technical means. In addition, in order to form the same structural elements, a person skilled in the art can also design a method that is not completely the same as the method described above. In addition, although the various embodiments are described separately above, this does not mean that the measures in the various embodiments cannot be advantageously used in combination.

In accordance with embodiments of the present disclosure, such as those described above, these embodiments do not describe all details in detail, nor do they limit the present disclosure to specific embodiments only. Obviously, a lot of modifications and changes can be made based on the above description. These embodiments are selected and specifically described in this specification in order to better explain the principles and practical applications of the present disclosure, so that those skilled in the art can make good use of the present disclosure and its modifications based on the present disclosure. The scope of protection of the present disclosure shall be subject to the scope defined in the claims of the present disclosure.

What is claimed is:

1. A daisy chain communication system, comprising:
a master controller;
a daisy chain including a first slave controller and a plurality of second slave controllers, the first slave controller being coupled to the master controller;
wherein the master controller is configured to transmit command information to the plurality of second slave controllers through the first slave controller, and receives network response information from the daisy chain for the command information,
the daisy chain is configured to perform an operation function including: dividing a network response period into a plurality of sub phases, and each of the second slave controller transmitting transmission data with a consistent data length to a slave controller of an upstream node cascaded therewith at each sub phase, wherein the transmission data includes one of response information of the second slave controller itself, response information of a slave controller of a downstream node and a first fake data; in a transfer order of the command information, the slave controller of the upstream node is a slave controller close to a side of the master controller; the slave controller of the downstream node is a slave controller away from the side of the master controller;
and the first slave controller transmitting the transmission data from the second slave controller cascaded therewith at each sub phase to the master controller until all the response information of the plurality of second slave controllers is transmitted to the master controller.

2. The daisy chain communication system according to claim 1, wherein the first slave controller is configured to receive the command information from the master controller; and transmit the command information sequentially to each second slave controller in a cascading order of the daisy chain.

3. The daisy chain communication system according to claim 1, wherein each second slave controller is configured to transmit the transmission data to the slave controller of the upstream node cascaded therewith in a case that the command information or a response request is received at each sub phase.

4. The daisy chain communication system according to claim 3, wherein each second slave controller is configured, so that in a case that the command information is received, the transmission data transmitted to the slave controller of the upstream node cascaded therewith is the response information of the second slave controller itself;
in a case that the response request is received, the transmission data transmitted to the slave controller of the upstream node cascaded therewith is one of the response information of the slave controller of the downstream node and the first fake data.

5. The daisy chain communication system according to claim 3, wherein the first slave controller is further configured to generate the response request at each sub phase after transmitting the transmission data from the second slave controller cascaded therewith to the master controller, and to transmit the response request sequentially to each second slave controller.

6. The daisy chain communication system according to claim 1, wherein the first slave controller is further configured to transmit the response information of the first slave controller itself to the master controller after receiving the command information.

7. The daisy chain communication system according to claim 1, wherein each of the first slave controller and the plurality of second slave controllers includes a first data buffer and a second data buffer,
wherein, in each slave controller, the second data buffer is configured to cache the transmission data from the slave controller of the downstream node,
the first data buffer is configured to store data of the slave controller itself, or to extract data from the second data buffer of the slave controller itself and transmit it to the slave controller of the upstream node or the master controller.

8. The daisy chain communication system according to claim 1, wherein a common protocol is adopted for communication between the master controller and the first slave controller.

9. The daisy chain communication system according to claim 1, wherein two interfaces are arranged in each slave controller, and each interface has a transmitting and receiving function;
the second slave controller located last in a cascading order is further configured to transmit a second fake data through its own idle interface after receiving the command information, wherein the second fake data has a same data length as the command information; the idle interface is an interface that is not coupled to other slave controllers.

10. The daisy chain communication system according to claim 1, wherein two interfaces are arranged in each slave controller, and each interface has a transmitting and receiving function;
the first slave controller is further configured to transmit a plurality of first fake data that has the same number as the plurality of second slave controllers through its own idle interface during the network response period; the idle interface is an interface that is not coupled to other slave controllers.

11. The daisy chain communication system according to claim 1, wherein
the daisy chain includes n second slave controllers, n being a positive integer greater than 1, when a communication interruption is in any two adjacent second slave controllers, n second slave controllers are divided into x second slave controllers and y second slave controllers based on a position of the communication interruption, both x and y being positive integers greater than or equal to 1, and x+y=n; the x second slave controllers and the first slave controller form a first daisy chain network; the y second slave controller and the first slave controller form a second daisy chain network.

12. The daisy chain communication system according to claim 11, wherein
when x is equal to y, the first daisy chain network and the second daisy chain network are configured to perform a same operation as the operation function; a total data length of the response information transmitted by each second slave controller in the first daisy chain network and the second daisy chain network is a sum of data lengths of x/y response information;
when x is greater than y, the first daisy chain network is configured to perform the same operation as the operation function; a total data length of the response information transmitted by each second slave controller in the second daisy chain network is a sum of data lengths of x response information;
when y is greater than x, the second daisy chain network is configured to perform the same operation as the operation function; a total data length of the response information transmitted by each second slave controller in the first daisy chain network is a sum of data lengths of y response information.

13. The daisy chain communication system according to claim 12, wherein
two interfaces are arranged in each slave controller, and each interface has a transmitting and receiving function; in the first daisy chain network or the second daisy chain network, the second slave controller located last in the cascading order is further configured to transmit a second fake data through its own idle interface after receiving the command information, wherein the second fake data has a same data length as the command information. the idle interface is an interface that is not coupled to other slave controllers.

14. The daisy chain communication system according to claim 13, wherein
when x is equal to y, a total data length of the response information transmitted by the first slave controller is a difference between the sum of the data lengths of the x/y response information and a data length of the command information;
when x is greater than y, the total data length of the response information transmitted by the first slave controller is a difference between the sum of the data lengths of the x response information and the data length of the command information;
When y is greater than x, the total data length of the response information transmitted by the first slave controller is a difference between the sum of the data lengths of the y response information and the data length of the command information.

15. A battery management system, comprising:
a battery pack including a plurality of battery modules; and
the daisy chain communication system of claim 1.

16. A daisy chain communication method, wherein the daisy chain includes a first slave controller and a plurality of second slave controllers, the first slave controller is coupled to a master controller, the communication method comprises:
step 1: transmitting command information to the plurality of second slave controllers through the first slave controller by the master controller;
step 2: performing a network response to the command information by the daisy chain;
step 3: dividing a network response period into a plurality of sub phases, and transmitting transmission data with a consistent data length by the second slave controller to a slave controller of an upstream node cascaded therewith at each sub phase, wherein the transmission data includes one of response information of the second slave controller itself, response information of a slave controller of a downstream node and a first fake data; in a transfer order of the command information, the slave controller of the upstream node is a slave controller close to a side of the master controller; the slave controller of the downstream node is a slave controller away from the side of the master controller; and
transmitting the transmission data from the second slave controller cascaded with the first slave controller to the master controller by the first slave controller at each sub phase until all the response information of the plurality of second slave controllers is transmitted to the master controller.

17. The daisy chain communication method according to claim 16, further comprising: arranging two interfaces in each slave controller, wherein each interface has a transmitting and receiving function;
wherein in the plurality of second slave controllers, the second slave controller located last in a cascading order is further configured to transmit a second fake data through its own idle interface after receiving the command information, the second fake data has a same data length as the command information; the idle interface is an interface that is not coupled to other slave controllers.

18. The daisy chain communication method according to claim 16, wherein two interfaces are arranged in each slave controller, and each interface has a transmitting and receiving function;
the first slave controller is further configured to transmit a plurality of first fake data that has the same number as the plurality of second slave controllers through its own idle interface during the network response period; the idle interface is an interface that is not coupled to other slave controllers.

19. The daisy chain communication method according to claim 16, wherein
the daisy chain includes n second slave controllers, n being a positive integer greater than 1, when a communication interruption is in any two adjacent second slave controllers, n second slave controllers are divided into x second slave controllers and y second slave controllers based on a position of the communication interruption, both x and y being positive integers greater than or equal to 1, and x+y=n; the x second slave controllers and the first slave controller form a first daisy chain network; the y second slave controller and the first slave controller form a second daisy chain network.

20. The daisy chain communication method according to claim 19, wherein
when x is equal to y, the first daisy chain network and the second daisy chain network are configured to perform a same operation as in step 3;
otherwise, a length of the response information transmitted by each second slave controller and the first slave controller is determined based on a maximum value in x and y.
